(19) United States
(12) Patent Application Publication
(10) Pub. No.: US 2014/0293280 A1
(43) Pub. Date: Oct. 2, 2014

(54) NANOSILICA SINTERED GLASS SUBSTRATE FOR SPECTROSCOPY

(71) Applicant: CORNING INCORPORATION, CORNING, NY (US)

(72) Inventors: Glenn Eric Kohnke, Corning, NY (US); Xinyuan Liu, Painted Post, NY (US); Marcel Potuzak, Corning, NY (US); Alranzo Boh Ruffin, Painted Post, NY (US); Millicent Kaye Weldon Ruffin, Painted Post, NY (US)

(73) Assignee: CORNING INCORPORATED a New York Corporation

(21) Appl. No.: 14/355,655

(22) PCT Filed: Nov. 2, 2012
(86) PCT No.: PCT/US2012/063201

§ 371 Date: May 1, 2014

Related U.S. Application Data
(60) Provisional application No. 61/557,488, filed on Nov. 9, 2011.

(51) Int. Cl. G01J 3/44

(52) U.S. Cl. CPC G01J 3/4412
USPC 356/301; 356/244; 427/162; 427/483; 427/585; 427/580; 427/569; 427/596; 205/109; 205/162

(57) ABSTRACT

Provided herein are substrates useful for surface-enhanced Raman spectroscopy (SERS), as well as methods of making substrates. The substrates comprise a support element; a nanoparticulate layer; a SERS-active layer in contact with said nanoparticulate layer; and optionally, an immobilizing layer disposed between said nanoparticulate layer and said support element; wherein if the optional immobilizing layer is not present, the nanoparticulate layer is thermally bonded to the support element; and if said optional immobilizing layer is present, said nanoparticulate layer thermally bonded to said immobilizing layer, and optionally, further thermally bonded to said support element. In addition, methods of making the substrates, along with methods of detecting and increasing a Raman signal using the substrates, are described herein.

This application claims the benefit of priority under 35 U.S.C. §119 of U.S. Provisional Application Ser. No. 61/557,488 filed on Nov. 9, 2011 the content of which is relied upon and incorporated herein by reference in its entirety.

### BACKGROUND

1. Field

Embodiments relate generally to the fields of Raman spectroscopy and spectroscopic imaging. Specifically, embodiments relate to dual- and multilayered substrates useful in surface enhanced Raman spectroscopic applications.

2. Description of the Related Art

Research on surface-enhanced Raman spectroscopy (SERS) is an area of intense interest because it provides the structural information content of Raman spectroscopy enhanced by an ultra-sensitive detection limit, allowing both quantitative and qualitative analysis of individual molecules. Detection of trace amounts of molecules is due to the large signal enhancements achieved with SERS, typically 10³-10⁶, as compared to spontaneous Raman scattering. While an exact description of the SERS phenomenon is complex, it is well known that the large SERS enhancement factors, achieved by placing the molecule(s) of interest in contact with a roughened metal surface, occur primarily through a combination of a chemical enhancement mechanism and an electromagnetic enhancement mechanism. More specifically, SERS sensitivity results from the amplification of the Raman signal due to a combination of 1) the electromagnetic enhancement factor associated with the substrate's surface plasmon excitation and 2) chemical enhancement factor related to the charge transfer between the substrate and analytes.

SERS is useful in providing ultra-sensitive detection and characterization of many organic and biomedically relevant molecules and processes. As a vibrational spectroscopy with extremely high spatial resolution, SERS is an effective tool for DNA or RNA analysis, medical diagnostics, drug discovery and detection of biological or chemical warfare agents for the Homeland Security initiatives. However, one of the major challenges in the commercial use of this technology is the development of SERS substrates that are easily fabricated, possess sample-to-sample signal reproducibility, have long shelf life, stability, and broad sample-substrate compatibility, and while at the same time are compact in size and are affordable.

In an attempt to overcome the difficulties associated with SERS substrates and take advantage of the potentially large signal enhancement factors associated with SERS, many different types of substrates have been developed. These substrates are typically made of silver, gold or copper and, in rare cases, alkali and transition metals. Some of the most commonly employed SERS substrates include noble metal colloids, electrochemically roughened electrodes, acid-etched metal foils, chemically produced silver island films, vapor deposited metal island films, and silver films over nanoparticles/nanostructures.

A number of “top-down” technologies have been developed to prepare SERS substrates. Electrochemical roughening was the first technique, but provided little control over surface features. Electron beam lithography (EBL) techniques provide precise control over surface topography; however, EBL is costly and is limited to small pattern areas that are not practical for many end-use analytical applications. More recently, alternative methods, such as nanosphere lithography (NSL), have been developed. NSL uses a tightly packed array of submicron silica or polymer beads was used as a template for thermal vapor deposition of Au or Ag patterns on the underlying substrate, which provides some control of the nanoscale morphology on the macroscale, and has been used for the detection of biochemical markers for Alzheimer's disease. Another recent top-down fabrication approach involves producing SERS substrates via deposition of gold cladding on top of one dimensional nm-scale pitch silica gratings (the parent grating) produced by holographic lithography on silicon wafers.

Alternatively, many “bottom-up” technologies have also has been used to prepare SERS substrates. Roughened metal electrodes and metal colloids were among the first SERS-active media to be used. These media have been extensively investigated in fundamental studies but are used mainly in laboratory settings owing to limited sample stability and/or reproducibility. A variety of substrates based on metal-covered nano-particles have subsequently been developed for use as solid-surface SERS substrates, such as metal nanoparticle island films, Metal-coated nanoparticle-based substrates, and polymer films with embedded metal nanoparticles.

Nevertheless, the current processes used to produce SERS substrate involve complex and/or tedious processes that are generally too expensive to be commercially viable. Additionally, many of the substrates produced with current processes are not commercially useful as they have limited shelf life, lack structural integrity, have limited reproducibility from substrate to substrate or require special conditions/environments to retain their activity. With the renewed interest and potential in SERS, there is clearly a need for a substrate that addresses the deficiencies of the current technologies.

### SUMMARY

An aspect of the present disclosure is to provide substrates useful for Raman spectroscopy and in particular, surface-enhanced Raman spectroscopy (SERS). Embodiments are directed to substrates useful for spectroscopy and, in particular, substrates that are useful for enhancing the Raman signal for analytes in effective contact with said substrates.

One embodiment comprises a substrate comprising a) a support element; b) a nanoparticulate layer; c) a SERS-active layer in contact with said nanoparticulate layer; and d) optionally, an immobilizing layer disposed between said nanoparticulate layer and said support element; wherein e) when said optional immobilizing layer is not present, said nanoparticulate layer is thermally bonded to said support element; and f) when said optional immobilizing layer is present, said nanoparticulate layer is thermally bonded to said immobilizing layer, and optionally, further thermally bonded to said support element. In some embodiments, when said optional immobilizing layer is not present, said thermal bonding of the nanoparticulate layer to the support element comprises embedding of said nanoparticulate layer into said support element; and when said optional immobilizing layer is present, said thermal bonding of the nanoparticulate layer to the support element comprises embedding of said nanoparticulate layer into said immobilizing layer, and optionally, embedding into said support element.

In some embodiments, the immobilizing layer is not present. In some embodiments, the immobilizing layer is present. In some embodiments, the immobilizing layer comprises a polymer, a glass, a sol gel, a resin, a metal or a metal oxide.

In some embodiments, the nanoparticulate layer comprises nanoparticles having an average radius of from about 5 nm to about 5,000 nm. In some embodiments, the average peak-to-peak distance of the nanoparticles comprises from about 2 radii to about 100 radii of the average radius of the nanoparticles along the shortest dimension. In some embodiments, the nanoparticulate layer comprises nanoparticles comprising at least one of glass, ceramic, metal, metal salt, polymer, metal oxide, metal sulfide, metal selenide, metal telluride, metal phosphate, quantum dots, inorganic nanoparticles, organic nanoparticles, nanotubes, nanofibers, nanowires, nanorods, nanoshells, fullerenes, or combinations thereof. In some embodiments, the nanoparticulate layer comprises nanoparticles having a softening point higher than the softening point of said support element or said optional immobilizing layer. In some embodiments, the nanoparticulate layer comprises nanoparticles having a softening point higher than the softening point of said support element or said optional immobilizing layer.

In some embodiments, the surface enhanced Raman spectroscopy active layer comprises at least one of a transition metal. In some embodiments, the total thickness of the surface enhanced Raman spectroscopy active layer is about 5 nm to about 1000 nm. In some embodiments, the support element comprises glass, quartz, ceramic, metal, inorganic elements or compounds, wood, paper, or polymer.

In some embodiments, the support element comprises glass, the nanoparticulate layer comprises nanoparticles, and the metal layer comprises at least one of Ag, Al, Au, Pt, Cu, Fe, Ru, Rh, Pd, Os, Ir, Ni, Zn, Mn, or Co, wherein the average peak-to-peak distance of the nanoparticles comprises from about 2 radii to about 100 radii of the average radius of the nanoparticles along the shortest dimension.

Another aspect is to provide methods of forming substrates useful for spectroscopic methods, and particularly for SERS. One embodiment comprises a method of forming a substrate comprising a) providing a support element; b) optionally forming an immobilizing layer on said support element; c) forming a nanoparticulate layer on said support element or optional said immobilizing layer to form a coated support element; d) heating said coated support element to a temperature that allows said nanoparticulate layer to bond to said support element, to said optional immobilizing layer, or to both said support element and said optional immobilizing layer to form a thermally treated support element; and e) forming a SERS active layer on said thermally treated support element. In some embodiments, the bonding comprises thermal bonding. In some embodiments, the nanoparticulate layer is embedded in the support element and/or the option immobilizing layer. In some embodiments, the immobilizing layer formation step occurs before the nanoparticulate layer formation step. In some embodiments, the nanoparticulate layer formation step occurs before the immobilizing layer formation step. In some embodiments, when said optional immobilizing layer is not present, said bonding of the nanoparticulate layer to the support element comprises embedding of said nanoparticulate layer into said support element; and when said optional immobilizing layer is present, said bonding of the nanoparticulate layer to the support element comprises embedding of said nanoparticulate layer into said immobilizing layer, and optionally, embedding into said support element.

In some embodiments of the method, the nanoparticulate layer comprises nanoparticles having an average radius of from about 5 nm to about 5,000 nm. In some embodiments, the average peak-to-peak distance of the nanoparticles comprises from about 2 radii to about 100 radii of the average radius of the nanoparticles along the shortest dimension. In some embodiments, the nanoparticulate layer comprises nanoparticles having a softening point higher than the softening point of said support element or said optional immobilizing layer.

In some embodiments, the optional immobilizing layer is not present and said heating is above the softening point of said support element, but below the softening point of said nanoparticulate layer. In other embodiments, the optional immobilizing layer is present and said heating is below the softening point of said optional immobilizing layer, and below the softening point of said nanoparticulate layer.

In some embodiments, said forming a nanoparticulate layer comprises dip coating, spin coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

In some embodiments, said forming a metal layer comprises sputter coating, plasma coating, dip coating, Langmuir-Blodgett deposition, chemical deposition, electrochemical deposition, spin coating, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

Another aspect is to provide methods of detecting spectroscopic signals from analytes in effective contact with embodiments of the substrates. In one embodiment, methods of detecting a spectroscopic signal comprise: a) bringing at least one analyte into effective contact with a substrate of one embodiment; illuminating said analyte with radiation from an excitation source; collecting or measuring the Raman scattering from said analyte. In some embodiments, the analyte is chemically bound to the SERS active layer. In some embodiments, the analyte is deposited on the substrate in a gas, liquid, or solid form.

Another aspect is to provide a method of increasing Raman signal intensity. In one embodiment, a method of increasing Raman signal intensity during surface-enhanced Raman spectroscopy, comprises: providing a substrate of one embodiment; bringing at least one analyte into effective contact with said substrate; and illuminating said analyte with radiation from an excitation source. In some embodiments, the analyte is chemically bound to the SERS active layer. In some embodiments, the analyte is deposited on the substrate in a gas, liquid, or solid form.

Embodiments are useful for, for example, detection of chemical or biological weapons, medical illnesses or conditions, explosives, contraband, pharmaceuticals, or biotechnology by improving and/or enhancing the SERS signal of analytes and providing a platform with good sample to sample reproducibility.

### FIGURES

FIG. 1. Scheme showing an embodiment of the present disclosure. The SERS active substrate comprises an Au coating on the SiO₂ microspheres sintered soda-lime glass substrates.

FIG. 2. SEM images of an embodiment of the present disclosure (FIG. 2A) top view and (FIG. 2B) cross-section)—silica spheres with radii of 100 nm packed on a soda lime glass substrate.

FIG. 3. An example of the topography for a gold-coated silica sintered glass substrate by AFM. FIG. 3A shows (a) three-dimensional view of 4 min Au coating. Longer deposition times will increase Au film thickness, but will also decrease substrate surface roughness, as shown in the comparison of the 1 min deposition time Au coating (FIG. 3B) to the 4 min Au coating (FIG. 3c).

FIG. 4. SERS spectra of 0.2 μl 0.01M methylene blue (“MB”) adsorbed on 30 nm thick gold-coated silica-sintered glass substrate, with glass substrate (“a”), MB adsorbed on glass (“b”) and 30 nm gold coating on glass (“c”), MB EtOH solution dried on glass slide (“d”) and dry MB powder (“e” and “f”) as controls.

FIG. 5. SERS spectra at 5 different analyzed spots demonstrate the uniformity across an embodiment of the present disclosure (30 nm Au-coated silica-sintered soda lime glass).

FIG. 6. (FIG. 6A) SERS spectra of MB adsorbed on a SiO₂ sintered embodiment of the present disclosure with different Au coating thicknesses; (FIG. 6B) SERS spectra of MB on a 30 nm Au coated embodiment of the present disclosure measured at different laser powers.

FIG. 7. Diagram of the support element (100) and nanoparticulate layer (101) showing the interstitial region (102) and peak-to-peak distance (103) shown at different radii: (FIG. 7A) d=2 radii (2 r); (FIG. 7B) d=2.5 r; and (FIG. 7C) d=3 r.

FIG. 8. Diagram of the support element (100), nanoparticulate layer (101) and SERS active layer (105), showing the interstitial region (102) and peak-to-peak distance (103) shown at different radii: (FIG. 8A) d=2 radii (2 r) and (FIG. 8B) d=2.5 r. In this embodiment, as the nanoparticles get closer, surface roughness is lost and SERS enhancement decreases.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description is provided as an enabling teaching of the currently known embodiments. To this end, those skilled in the relevant art will recognize and appreciate that many changes can be made to the various aspects of the disclosure described herein, while still obtaining beneficial results. It will also be apparent that some of the desired benefits of the present embodiments can be obtained by selecting some of the features without utilizing other features. Accordingly, those who work in the art will recognize that many modifications and adaptations to the embodiments are possible and can even be desirable in certain circumstances and are a part of the present disclosure. Thus, the following description is provided as illustrative of the principles of the present disclosure and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

### DEFINITIONS

In this specification and in the claims which follow, reference will be made to a number of terms which shall be defined to have the following meanings:

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

The term “support element” refers to a solid layer used to support the nanoparticulate layer, optional immobilizing layer, and SERS active layer. The support element may generally comprise any material with sufficient mechanical properties to support the optional immobilizing layer, the nanoparticulate layer and SERS active layer. Examples of possible materials for the support element include, but are not limited to, glasses, inorganic or metal oxides, metals, polymers, paper, wood, and graphite. In some embodiments, the support element comprises a glass, ceramic, or inorganic oxide. In some embodiments, the support element comprises a glass. The support element may be flat and of a size and shape that would make it practical for commercial or laboratory use, but may also be any size or shape. In those embodiments where the nanoparticulate layer is thermally bonded to or interacalated into the support element, the support element comprises a material that is capable of thermally bonding and/or embedding the nanoparticulate layer, for example, but not limited to, a glass or inorganic oxide.

The term “nanoparticulate layer” refers to a material coating with features on the scale of about 1 nm to about 10,000 nm. The features may comprise individual particles, for example nanoparticles, combinations of particles, or be features on larger objects.

The term “nanoparticle” refers to a particle/component with an average diameter along the shortest axis of between about 1 and about 10,000 nm. Nanoparticles further comprise other nanoscale compositions, such as nanoclusters, nanopowders, nanocrystals, and large-scale molecular components, such as polymers and dendrimers. Nanoparticles may comprise any material compatible with embodiments, such as, but not limited to metal, glass, ceramic, inorganic or metal oxide, polymer, or organic molecules or combination thereof.

The terms “SERS active layer” and “surface enhanced Raman active layer” refer to a metal, metal salt, metal oxide, alloy or metal-containing compound or combination thereof that is capable of enhancing the Raman signal of an analyte within effective contact with the metal layer, particularly via the mechanism of SERS. Without wanting to be limited to a particular theory, it is thought that the SERS mechanism of the enhancement is either based on excitation of localized surface plasmons, the formation of charge-transfer complexes, or a combination of the two.

The term “immobilizing layer” refers to an optional layer that may be used, at least in part, to bond the nanoparticulate layer to the support element. The immobilizing layer may comprise any material compatible with bonding the nanoparticulate layer to the support element in the embodiment in which it is used. The nanoparticulate layer may be bonded to/embedded in the immobilizing layer. Said bonding may comprise thermal bonding. The nanoparticulate layer may be embedded in the immobilizing layer and further embedded in and/or bonded to the support element.

The term “embed” or “embedded” refers to the inclusion of the individual components of the nanoparticulate layer into either the immobilizing layer and/or the support element. In being embedded, the components of the nanoparticulate layer retain their individual structure and are not mixed, dissolved, or otherwise dispersed into the immobilizing layer and/or support element.

The term “effective contact” refers to any condition or situation wherein the analyte is within sufficient proximity of the SERS active layer to allow for surface enhancement of the spectroscopic signal of the analyte. Effective contact may be obtained through physically, chemically, or mechanically bonding to the analyte to the SERS active layer, physically, chemically, mechanically depositing the analyte, in solid, gas or liquid phase on the SERS active layer, or when may be obtained in gas phase or in solution by passing a gas or liquid across the surface of the SERS active layer.

Unless defined otherwise, all technical and scientific terms herein have the same meaning as commonly understood by one of ordinary skill in the art. Abbreviations, which are well known to one of ordinary skill in the art, may be used (e.g., “h” or “hr” for hour or hours, “Ag” for silver, “g” or “gm” for gram(s), “mL” for milliliters, and “RT” for room temperature, “nm” for nanometers, and like abbreviations).

### Raman Active Substrates

A first aspect is to provide substrates useful for spectroscopy, such as Raman spectroscopy, and in particular, surface-enhanced Raman spectroscopy (SERS). Embodiments may be useful for any number of spectroscopic techniques, but are especially useful for Raman spectroscopy, and most useful for surface-based Raman techniques, such as SERS and surface enhanced resonance Raman spectroscopy (SERRS). In some embodiments, the present disclosure provides a substrate capable of enhancing the Raman signal of a molecule in effective contact with the substrate. In some embodiments, the improved properties is/are easy fabrication, sample-to-sample signal reproducibility, long shelf life, stability, broad sample compatibility, compact size, uniformity over relatively large areas, and/or affordability. Embodiments provide substrates that are useful for improving, enhancing, modifying, strengthening, amplifying, boosting, augmenting, intensifying, or in any way increasing the Raman signal for analytes in effective contact with the substrate. Increases in Raman signal of analytes in effective contact with embodiments can comprise from about 10¹ to about 10⁹, from about 10² to about 10⁸, from about 10³ to about 10⁷, from about 10³ to about 10⁶, from about 10³ to about 10⁵, from about 10³ to about 10⁴, from about 10⁵ to about 10⁹, from about 10⁵ to about 10⁸, from about 10⁵ to about 10⁷, from about 10⁵ to about 10⁶, or about 10¹, 10², 10³, 10⁴, 10⁵, 10⁶, 10⁷, 10⁸, or 10⁹.

One embodiment comprises a substrate comprising a) a support element; b) a nanoparticulate layer; c) a SERS-active layer in contact with said nanoparticulate layer; and d) optionally, an immobilizing layer disposed between said nanoparticulate layer and said support element; wherein e) if said optional immobilizing layer is not present, said nanoparticulate layer is thermally bonded to said support element; and f) if said optional immobilizing layer is present, said nanoparticulate layer is thermally bonded to said immobilizing layer, and optionally, further thermally bonded to said support element.

Another embodiment comprises a substrate comprising a) a support element; b) a nanoparticulate layer; c) a SERS-active layer in contact with said nanoparticulate layer; and d) optionally, an immobilizing layer disposed between said nanoparticulate layer and said support element; wherein e) if said optional immobilizing layer is not present, said nanoparticulate layer embedded in said support element; and f) if said optional immobilizing layer is present, said nanoparticulate layer is embedded in said immobilizing layer, and optionally, further embedded in said support element.

In some embodiments the support element comprises glass, ceramic, an inorganic oxide, metal, metal oxide, graphite, polymer, wood, or paper. In some embodiments, the support element comprises an inorganic material. The inorganic material, in one embodiment, comprises a material selected from a glass, a ceramic, a glass ceramic, sapphire, silicon carbide, a semiconductor, and combinations thereof. In another embodiment, the support element comprises an organic material. The organic substrate, in one embodiment comprises a material selected from a polymer, polystyrene, polymethylmethacrylate (PMMA), a thermoplastic polymer, a thermoset polymer, and combinations thereof. The substrate can comprise one or more layers, according to one embodiment. For example, the substrate could comprise one or more layers of inorganic, organic, or a combination of inorganic and/or organic materials. In some embodiments, the support element comprises glass, an inorganic oxide, or ceramic. In some embodiments, the support element comprises glass, such as soda lime glass. When the support element is glass, it may be formed by those methods known in the art such as, but not limited to, float techniques, molding, casting, and down draw methods, such as slot draw, fusion draw, or the like. In some embodiments, the support element has at least one flat surface. In some embodiments, the support element has a sheet-like structure comprising two flat surfaces that are parallel in the x- and y-directions, wherein the dimensions in the x- and y-directions are significantly greater than in the z-direction. In some embodiments, as used herein, significantly greater comprises greater than 5×, 10×, 20×, 50×, or 100×.

In some embodiments the nanoparticulate layer comprises nanoparticles, nanotubes, or microparticles, quantum dots, nanofibers, nanowires, nanorods, nanoshells, fullerenes, or combinations thereof. In some embodiments, the nanoparticulate layer comprises a glass, ceramic, glass ceramic, polymer, a semiconductor, a metal, a metal oxide, a mixed metal oxide, metal salt, metal sulfide, metal selenide, metal telluride, metal phosphate, inorganic nanoparticles, organic nanoparticles, an inorganic oxide, graphite, fullerene, or nanotubes, and combinations thereof. In some embodiments, the nanoparticulate layer comprises sapphire, silicon carbide, silica, alumina, zirconia, glass frit, silica glass, soda lime glass, single or multi-element oxide, such as Al₂O₃, Bi₂O₃, Co₃O₄, CoFe₂O₄, MnFe₂O₄, or BaFe₁₂O₁₉, or compounds, such as AlN, BN, LaF₃, SiC, Si₃N₄, or TiC. The composition of the nanoparticulate layer can vary and it is not required that all particles in the nanoparticulate layer comprise the same composition.

In some embodiments, the nanoparticulate layer comprises nanoparticles. In some embodiments, nanoparticles comprise any material compatible with the support element or immobilizing layer. In some embodiments, nanoparticles comprise glass, ceramic, glass ceramic, polymer, a semiconductor, a metal, a metal oxide, a mixed metal oxide, metal salt, metal sulfide, metal selenide, metal telluride, metal phosphate, inorganic nanoparticles, organic nanoparticles, an inorganic oxide, graphite, fullerene, or nanotubes, and combinations thereof. In some embodiments, nanoparticles comprise metal, metal oxide, glass, ceramic, or inorganic oxide. In some embodiments, the nanoparticles comprise sapphire, silicon carbide, silica, alumina, zirconia, glass frit, silica glass, soda lime glass, single or multi-element oxide, such as Al₂O₃, Bi₂O₃, Co₃O₄, CoFe₂O₄, MnFe₂O₄, or BaFe₁₂O₁₉, Or compounds, such as AlN, BN, LaF₃, SiC, Si₃N₄, or TiC. The composition of any one or more nanoparticles can vary and it is not required that all nanoparticles comprise the same composition. Nanoparticles may have any shape and surface features. The structure and geometry of a nanoparticle can vary and the present disclosure is not intended to be limited to any particular geometry and/or structure. Embodiments herein comprise a plurality of nanoparticles and each individual nanoparticle or group of nanoparticles can have either the same or different structure and/or geometry than other nanoparticles. For example, in some embodiments, nanoparticles may be spherical, oblong, polyhedral, flakes, or take on crystalline-type structures. In some embodiments nanoparticle surfaces may be smooth, rough, ordered, disordered, or patterned.

It should be understood that particle sizes of nanoparticles can be distributional properties. Further, in some embodiments, the nanoparticles may have different sizes or distributions or more than one size or distribution. Thus, a particular size can refer to an average particle diameter or radius which relates to the distribution of individual particle sizes. In some embodiments, the size of the nanoparticles used is dependent on the wavelength of the excitation source. In some embodiments, the size of the nanoparticles is dependent on the analyte. In some embodiments, the nanoparticles of the nanoparticulate layer have an average diameter from about 5 nm to about 10000 nm, from about 5 nm to about 7500 nm, from about 5 nm to about 5000 nm, from about 5 nm to about 2500 nm, from about 5 to about 2000, from about 5 to about 1500, from about 5 to about 1250, 5 nm to about 1000 nm, from about 5 nm to about 750 nm, from about 5 nm to about 500 nm, from about 5 nm to about 250 nm, from about 5 to about 200, from about 5 to about 150, from about 5 to about 125, from about 5 to about 100, from about 5 to about 75, from about 5 to about 50, from about 5 to about 25, from about 5 to about 20, from about 10 nm to about 1000 nm, from about 10 nm to about 750 nm, from about 10 nm to about 500 nm, from about 10 nm to about 250 nm, from about 10 to about 200, from about 10 to about 150, from about 10 to about 125, from about 10 to about 100, from about 10 to about 75, from about 10 to about 50, from about 10 to about 25, from about 10 to about 20, from about 20 nm to about 1000 nm, from about 20 nm to about 750 nm, from about 20 nm to about 500 nm, from about 20 nm to about 250 nm, from about 20 to about 200, from about 20 to about 150, from about 20 to about 125, from about 20 to about 100, from about 20 to about 75, from about 20 to about 50, from about 20 to about 25, from about 50 nm to about 1000 nm, from about 50 nm to about 750 nm, from about 50 nm to about 500 nm, from about 50 nm to about 250 nm, from about 50 to about 200, from about 50 to about 150, from about 50 to about 125, from about 50 to about 100, from about 50 to about 75, from about 100 nm to about 1000 nm, from about 100 nm to about 750 nm, from about 100 nm to about 500 nm, from about 100 nm to about 250 nm, from about 100 to about 200, from about 100 to about 150, or about 5 nm, 10 nm, 20 nm, 25 nm, 50 nm, 75 nm, 100 nm, 125 nm, 150 nm, 175 nm, 200 nm, 250 nm, 300 nm, 400 nm, 500 nm, 600 nm, 700 nm, 750 nm, 800 nm, 900 nm, 1000 nm, 1250 nm, 1500 nm, 2000 nm, 2500 nm, 5000 nm, 7500 nm, or 10,000 nm.

In some embodiments, the nanoparticles of the nanoparticulate layer have a glass transition temperature, annealing temperature, deformation point, softening point, and/or melting point higher than the glass transition temperature, the annealing temperature, the deformation point, the softening point, and/or the melting point of the support element. In some embodiments the nanoparticles of the nanoparticulate layer have a glass transition temperature, annealing temperature, deformation point, softening point, and/or melting point lower than the glass transition temperature, the annealing temperature, the deformation point, the softening point, and/or the melting point of the support element. In some embodiments, the nanoparticles have a glass transition temperature, annealing temperature, deformation point, softening point, and/or melting point about equal to the glass transition temperature, the annealing temperature, the deformation point, the softening point, and/or the melting point of the support element.

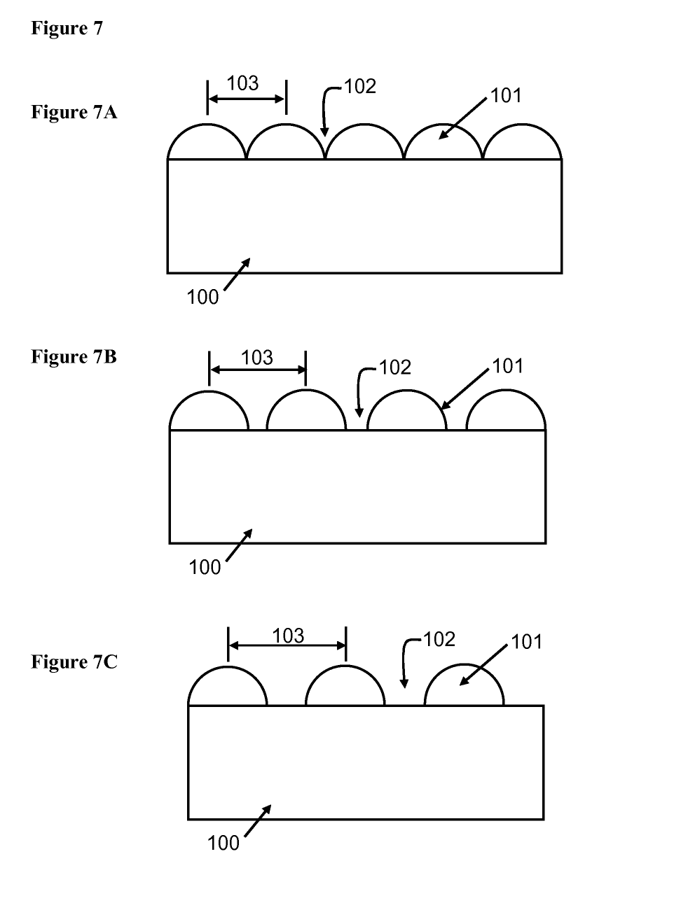

In some embodiments, the morphology of the nanoparticulate layer is integral to the enhancement of the SERS signal. In some embodiments, the morphology comprises the surface roughness of the nanoparticulate layer. In some embodiments, the morphology comprises the surface roughness of the SERS-active layer and nanoparticulate layer. In some embodiments, the morphology comprises the surface roughness of the SERS-active layer. Surface “roughness,” considered essential to maximizing the enhancement of the SERS signal, comprises nanometric-scale features on the surface that have complex electromagnetic modes that can modify the spectroscopic properties of incident light. (See, e.g., F. J. Garcia-Vidal and J. B. Pendry, Collective Theory for Surface Enhanced Raman Scattering, 77 PHYS. REV. LETT. 1163-1166 (1996), hereby incorporated by reference in its entirety). In some embodiments, surface roughness is described by the arithmetic average of absolute values of surface height, Rₐ. In some embodiments, surface roughness may be described by the root mean square of the surface height values, R_{q}. In some embodiments, surface roughness comprises the nanoparticle interstitial space, the curved regions created by multiple particles situated within close proximity to each other (FIG. 7). In some embodiments, surface roughness comprises the interstitial space of the SERS-active coated nanoparticles (see below). The interstitial regions between the particles provide new localized modes of surface plasmon with extraordinary field strengths. In some embodiments, close proximity comprises within about 100, 75, 50, 25, 20, 15, 10, 8, 7, 6, 5, 4, 3, 2.5, 2, 1.5, 1, 0.75, 0.5, 0.25, or 0 radii of the average nanoparticle size along the shortest dimension.

In some embodiments, the roughness of the nanoparticulate layer is controlled via nanoparticle morphology, size, packing pattern, and height. In some embodiments, nanoparticles with aspect ratios in the range of 10:1 to 75:1 are optimum for enhanced Raman scattering.

The nanoparticulate layer may comprise any structural formation that allows for SERS enhancement. In some embodiments, the nanoparticulate layer comprises from about a monolayer to about a bilayer of nanoparticles. In some embodiments, the nanoparticulate layer comprises about a monolayer of nanoparticles. In some embodiments, the nanoparticulate layer comprises multiple layers of nanoparticles. In some embodiments, the nanoparticulate layer is ordered, disordered, random, packed, for example close packed, or arranged, for example via surface modification. In some embodiments, the nanoparticulate layer comprises nanoparticles that are clustered, agglomerated or ordered into isolated groups.

Generally, dense or close packing will provide more nanostructured SERS active sites per unit surface area than non-dense packing. The limits of the packing density are influenced by the particle size. In some embodiments, useful average peak-to-peak distances (measured from apex to apex of adjacent nanoparticles) range from about 15 nm to 15,000 nm for nanoparticle sizes ranging from about 10 nm to about 10,000 nm (FIG. 7). In some embodiments, peak to peak distances of about 15, 30, 50, 75, 100, 150, 200, 250, 300, 350, 400, 450, 500, 600, 700, 800, 900, or 1000 nm with particle sizes of about 15, 30, 50, 75, 100, 150, 200, 250, 300, 350, 400, 450, 500, 600, 700, 800, 900, or 1000 nm are optimal for maximizing SERS enhancement. In some embodiments, average peak to peak distances comprise about 100, 75, 50, 25, 20, 15, 10, 8, 7, 6, 5, 4, 3, 2.5, or 2 radii of the average nanoparticle size along the shortest dimension.

Embodiments comprise a nanoparticulate layer bonded to the immobilizing layer and/or the support element. In one embodiment, the bonding is thermal bonding. In one embodiment, thermal bonding occurs at a temperature higher, lower or about the glass transition temperature, the annealing temperature, the deformation point, the softening point, and/or melting point of the immobilizing layer and/or support element. In some embodiments where the support layer is a polymer, the bonding occurs at the glass transition temperature or at the Vicat softening point (ASTM D1525). In some embodiments where the support element is a glass, the bonding occurs at the deformation point, dilatometric softening point, or Littleton softening point. In one embodiment, the nanoparticulate layer is embedded in the immobilizing layer and/or the support element. In one embodiment, embedding occurs via a thermal mechanism, such as heating of the immobilizing layer and/or support element to allow the nanoparticulate layer to embed into the immobilizing layer and/or support element. In one embodiment, embedding occurs at a temperature higher, lower or about the glass transition temperature, the annealing temperature, the deformation point, the softening point, and/or melting point of the immobilizing layer and/or support element. In some embodiments, the particles of the nanoparticulate layer sink into the surface under their own weight. In other embodiments, a force may be applied to either the support element or the nanoparticulate layer to embed them in the glass substrate.

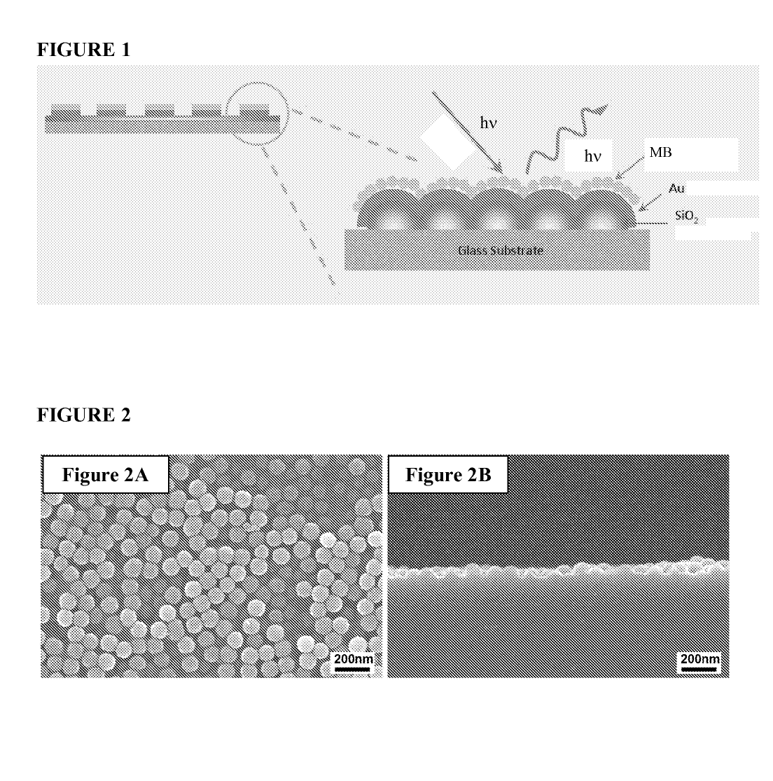

In some embodiments, nanoparticles are partially embedded in the immobilizing layer and/or support element so as to secure, bond, or adhere the nanoparticles to the support element. Nanoparticles may, in some embodiments, be partially embedded in the immobilizing layer and/or support element by heating immobilizing layer and/or support element to a temperature above glass transition temperature, the annealing temperature, the deformation point, the softening point, and/or melting point of the immobilizing layer and/or support element, causing the immobilizing layer and/or support element to soften and allow nanoparticles to partially sink into—and embed in—the surface of the immobilizing layer and/or support element, as schematically shown in FIG. 1b. FIG. 2b is a scanning electron micrograph of a side view of a surface of a support element in which the nanoparticles have been embedded in the surface of the support element by heating the support element to a temperature above its anneal point and allowing the nanoparticles to sink into the surface. Alternatively, in some embodiments the step of bonding the nanoparticulate layer to the support element comprises partially filling spaces between the particles with a immobilizing layer.

In some embodiments, a majority of the particles in the nanoparticulate layer has a portion of its volume above the surface of the immobilizing layer and/or support element it is disposed on. In some embodiments the portion is less than ¾ of the volume of the particle. In one embodiment, the portion is less than ⅔ of the volume of the particle, for example, less than ½, for example, less than ⅓. In some embodiments, the nanoparticulate layer is embedded in the immobilization layer to a depth less than about half (i.e., less than about 50%) of the diameter or major dimension of the nanoparticulate layer. In other embodiments, the depth is less than about three eighths (i.e., less than about 37.5%) of the diameter of the nanoparticulate layer. In still other embodiments, the depth is less than about one fourth (i.e., less than about 25%) of diameter of the nanoparticulate layer.

In some embodiments, the nanoparticulate layer is embedded in both the immobilizing layer and the support element. In some embodiments, the nanoparticulate layer is embedded in the immobilization layer and the support element to a depth less than about half (i.e., less than about 50%) of the diameter or major dimension of the nanoparticulate layer. In other embodiments, the depth is less than about three eighths (i.e., less than about 37.5%) of the diameter of the nanoparticulate layer, in still other embodiments, less than about one fourth (i.e., less than about 25%) of diameter of the nanoparticulate layer.

In some embodiments, the feature size can be determined by the distribution of particles and may not be impacted by, for example, heating conditions such as heating temperature and time. Heating temperature and time can affect the depth of particle sinking and in turn the spacing between the particles. Higher temperatures and/or longer heating time may cause the particles to sink deeper into the substrate, for example. The surface height of the features may be controlled and optimized, for example, by adjusting the heating conditions. The process offers the possibility of being run in a continuation fashion prior to cutting the sheet into individual pieces and would also work with individual pieces. The features, in some embodiments, are densely packed and only on one surface.

In another aspect, embodiments comprise a SERS active layer. In some embodiments, the SERS active layer comprises a metal or metal oxide, salt, for example hydrate, sulfate, phosphate or chloride, alloy, solvate, or complex. In some embodiments, the SERS active layer comprises at least one of a transition, alkali, alkali earth metal, or an oxide thereof. In some embodiments, the SERS active layer comprises at least one of Ag, Al, Au, Pt, Cu, Fe, Ru, Rh, Pd, Os, Ir, Ni, Zn, Mn, Co, an alkali metal, or an oxide thereof. In some embodiments, the SERS active layer comprises Ag, Al, Au, Pt, Cu, Fe, Ru, Rh, Pd, Os, Ir, Ni, Zn, Mn, or Co. In some embodiments, the SERS active layer comprises a coating completely covering the nanoparticulate layer. In some embodiments, the SERS active layer comprises a coating over “islands” or discrete areas of the nanoparticulate layer. In some embodiments, the SERS active layer comprises two or more metals or metal oxides.

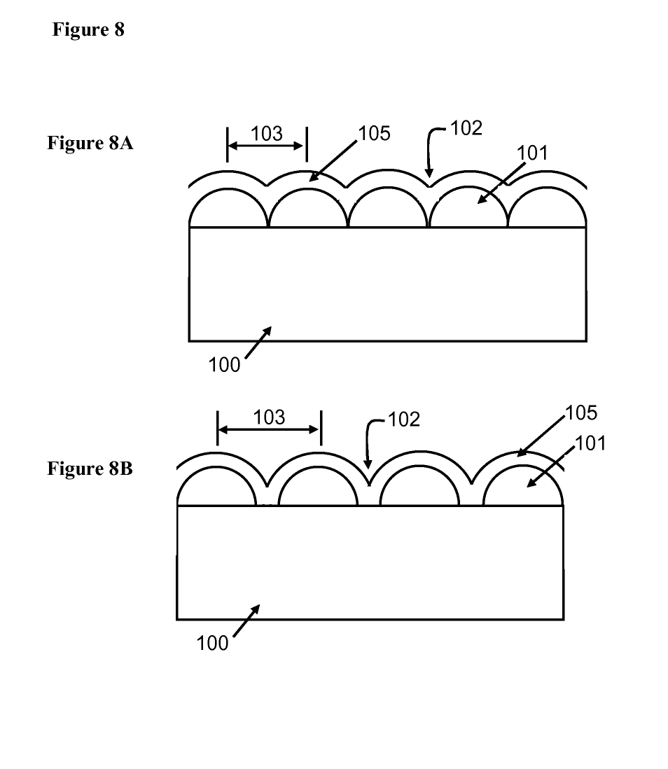

The thickness of the SERS active layer is an important parameter in the enhancement of the Raman signal. SERS active layer thickness can affect plasmon resonance. Additionally, for densely packed nanoparticles, metal thickness will affect the surface roughness more significantly than for non-dense packing particles. As the packing density decreases, the range narrows and shifts to thinner films. As noted previously, the morphology and/or surface roughness effects the SERS enhancement. In some embodiments, surface roughness comprises the interstitial space of the SERS-active coated nanoparticles. In some embodiments, the coating of the nanoparticles creates a nanoparticle with a radius greater than the radius of the particle itself. As the nanoparticles are packed more closely together, the nanoparticle interstitial regions may become “filled” with the SERS active layer (FIG. 8). Therefore, in some embodiments, the spacing of the nanoparticles comprises a spacing that provides an interstial angle that enhances the SERS signal when a surface enhanced Raman spectroscopy layer is present. In some embodiments, the nanoparticle spacing is determined by optimizing the SERS active layer thickness and the interstitial angle. In some embodiments, useful average peak to peak distances of 100, 75, 50, 25, 20, 15, 10, 8, 7, 6, 5, 4, 3, 2.5, or 2 radii of the average nanoparticle size along the shortest dimension. In some embodiments, close proximity comprises within about 100, 75, 50, 25, 20, 15, 10, 8, 7, 6, 5, 4, 3, 2.5, 2, 1.5, 1, 0.75, 0.5, 0.25, or 0 radii of the average radius of the nanoparticles along the shortest dimension.

In some embodiments, the thickness of the SERS active layer is dependent on the size of the particles in the nanoparticulate layer. In some embodiments, the thickness of the SERS active layer is dependent on the analyte. In some embodiments, the thickness of the SERS active layer is dependent on wavelength of the excitation source. In some embodiments, the thickness of the SERS active layer is dependent on required Raman enhancement needed. In some embodiments, the total thickness of the SERS active layer is from about 5 nm to about 100 nm, from about 5 nm to about 90 nm, from about 5 nm to about 80 nm, from about 5 nm to about 70 nm, from about 5 nm to about 60 nm, from about 5 nm to about 50 nm, from about 5 nm to about 40 nm, from about 5 nm to about 30 nm, from about 5 nm to about 20 nm, from about 5 nm to about 10 nm, from about 10 nm to about 100 nm, from about 10 nm to about 90 nm, from about 10 nm to about 80 nm, from about 10 nm to about 70 nm, from about 10 nm to about 60 nm, from about 10 nm to about 50 nm, from about 10 nm to about 40 nm, from about 10 nm to about 30 nm, from about 10 nm to about 20 nm, from about 20 nm to about 100 nm, from about 20 nm to about 90 nm, from about 20 nm to about 80 nm, from about 20 nm to about 70 nm, from about 20 nm to about 60 nm, from about 20 nm to about 50 nm, from about 20 nm to about 40 nm, from about 20 nm to about 30 nm, from about 30 nm to about 100 nm, from about 30 nm to about 90 nm, from about 30 nm to about 80 nm, from about 30 nm to about 70 nm, from about 30 nm to about 60 nm, from about 30 nm to about 50 nm, from about 30 nm to about 40 nm, from about 40 nm to about 100 nm, from about 40 nm to about 90 nm, from about 40 nm to about 80 nm, from about 40 nm to about 70 nm, from about 40 nm to about 60 nm, from about 40 nm to about 50 nm, from about 50 nm to about 100 nm, from about 50 nm to about 90 nm, from about 50 nm to about 80 nm, from about 50 nm to about 70 nm, from about 50 nm to about 60 nm, or about 5 nm, 10 nm, 20 nm, 30 nm, 40 nm, 50 nm, 60 nm, 70 nm, 80 nm, 90 nm, 100 nm.

In some embodiments, the immobilizing layer is not present. In some embodiments, the immobilizing layer is present. In some embodiments, the immobilizing layer is applied by dip coating, spin coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge, gravure printing, doctor blading, spray-coating, slot die coating, or chemical etching. In some embodiments, the immobilizing layer is applied by spin-coating, dip-coating, Langmuir-Blodgett deposition, gravure printing, doctor blading, spray-coating, or slot die coating. In some embodiments, the immobilizing layer comprises a polymer, a glass, a sol gel, a resin, a ceramic, a glass ceramic, an inorganic or organic oxide, a water glass, a metal or a metal oxide. In some embodiments, the immobilizing layer comprises nanoparticles. In some embodiments, the immobilizing layer comprises at least one inorganic oxide, such as but not limited to zirconia (ZrO₂), tin oxide (SnO₂), SiO, and SiO₂. In some embodiments, the immobilizing layer comprises a water glass, silicon alkoxide, or a silsesquioxane (SSQ). As used herein, the term “silsesquioxane” refers to compounds having the empirical chemical formula RSiO_{1.5}, where R is either hydrogen or an alkyl, alkene, aryl, or arylene group. In one embodiment, the immobilizing layer is heat-treated at a temperature of about 300° C. and, in some embodiments, at a temperature in a range from about 100° C., 150° C., 200° C., 250° C., 300° C., 350° C., 400° C., 450° C., 500° C., 550° C., 600° C., 650° C., or 700° C. up to about 750° C. In some embodiments, the immobilizing layer is heat-treated at a temperature of about 250° C. to about 350° C., wherein the SSQ is converted to a network structure. In another embodiment, the immobilizing layer is heated or annealed at a temperature of at least about 350° C., wherein the SSQ resin structure is converted to silica via thermal dissociation of Si—H with no affect on the nanoparticulate layer if it comprises SiO₂ nanoparticles.

In some embodiments, the immobilizing layer has a thickness of from about 1 nm to about 10 μm, or about 1 nm, 2 nm, 3 nm, 5 nm, 10 nm, 15 nm, 20 nm, 25 nm, 30 nm, 40 nm, 50 nm, 75 nm, 100 nm, 125 nm, 150 nm, 175 nm, 200 nm, 250 nm, 300 nm, 350 nm, 400 nm, 500 nm, 600 nm, 700 nm, 800 nm, 1 μm, 2 μm, 3 μm, 4 μm, 5 μm, 6 μm, 7 μm, 8 μm, 9 μm, or 10 μm. In some embodiments, the immobilizing layer has a thickness that is on the order of the size of the particles in the nanoparticulate layer.

A second aspect is to provide methods of forming substrates useful for spectroscopic methods, and particularly for SERS. One embodiment comprises a method of forming a substrate comprising a) providing a support element; b) optionally forming an immobilizing layer on said support element; c) forming a nanoparticulate layer on said support element or optional said immobilizing layer to form a coated support element; d) heating said coated support element to a temperature that allows said nanoparticulate layer to bond to said support element, to said optional immobilizing layer, or to both said support element and said optional immobilizing layer to form a thermally treated support element; and e) forming a SERS active layer on said thermally treated support element. In some embodiments, the bonding comprises thermal bonding. In some embodiments, the nanoparticulate layer is embedded in the support element and/or the optional immobilizing layer. In some embodiments, the immobilizing layer formation step occurs before the nanoparticulate layer formation step. In some embodiments, the nanoparticulate layer formation step occurs before the immobilizing layer formation step.

In some embodiments, forming an immobilizing layer comprises dip coating, spin coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge, gravure printing, doctor blading, spray-coating, slot die coating, or chemical etching.

In some embodiments, the heating of the coated support element comprises heating to a temperature that is above the glass transition temperature, the annealing temperature, the deformation point, the softening point, and/or the melting point of said support element and/or said optional immobilizing layer. In some embodiments, the heating of the coated support element comprises heating to a temperature that is below the glass transition temperature, the annealing temperature, the deformation point, the softening point, and/or the melting point of said support element and/or said optional immobilizing layer. In some embodiments, the heating is done via resistance heating, combustion heating, induction heating, or electromagnetic heating. In one embodiment, heating comprises thermally bonding, embedding, and/or sintering at least a portion of the coated support element, at least a portion of the nanoparticulate layer, at least a portion of the immobilizing layer, or a combination thereof. The entire coated support element can also be heated such that substantially all of the nanoparticulate layer is thermally bonded, embedded, or sintered. Heating can be realized by localized heating such as by using a laser, by radiant or convection heating such as by using a furnace, or by using a flame, or by using a combination of localized and radiant or convection or flame heating. One embodiment comprises heating the coated support element as the coated support element is being formed. For example, a self-assembled monolayer already transferred on a portion of the substrate can be heated with a laser while formation is occurring on another portion of the support element.

In some embodiments, the formation of the nanoparticulate layer comprises dip coating, spin coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

In one embodiment, the nanoparticulate layer may be formed by using a self-assembly process, by soot deposition, or using an adhesive formed monolayer. A self-assembly method can be, for example, functionalizing particles with a silane, spreading the functionalized particles on water to form a monolayer, and putting the substrate through the monolayer to deposit the particles onto the substrate; or by other self-assembly methods known in the art. A soot deposition method can be, for example, passing reactants through, for example, a burner to produce soot particles and depositing the soot particles onto the substrate; or by other soot deposition methods known in the art. An adhesive monolayer forming method can be, for example, applying an adhesive to a substrate, applying particles to the adhesive coated substrate, and removing the excess particles to form a monolayer of particles on the substrate; or by other adhesive monolayer forming methods known in the art. The process is not specific to a type of substrate glass. In some embodiments, the substrate may be heated in a furnace above its softening point with a weight on top of the sample and subsequently cooled.

In one embodiment, the nanoparticulate layer is formed by dip-coating. In one embodiment, the dip coating is done with a suspension or a dispersion comprising a liquid carrier and nanoparticles. The liquid carrier can generally be chosen with properties such that it will not accumulate on the subphase. Properties that may be relevant to the ability of the liquid carrier to not accumulate on the subphase liquid include, but are not limited to, the miscibility of the liquid carrier with the subphase, and the vapor pressure of the liquid carrier. In one embodiment, the liquid carrier can be chosen to be miscible or at least partially miscible in the subphase. In one embodiment, the liquid carrier can be chosen to have a relatively high vapor pressure. The liquid carrier can also be chosen as one that can easily be recovered from the subphase. The liquid carrier can also be chosen as one that is not considered environmentally or occupationally hazardous or undesirable. In another embodiment, the liquid carrier can be chosen based on one of, more than one of, or even all of the above noted properties. In some instances, properties other than those discussed herein may also be relevant to the choice of liquid carrier.

In an embodiment, the liquid carrier can be, for example, a single solvent, a mixture of solvents, or a solvent (a single solvent or a mixture of solvents) having other non-solvent components. Exemplary solvents that can be utilized include, but are not limited to, a hydrocarbon, a halogenated hydrocarbon, an alcohol, an ether, a ketone, and like substances, or mixtures thereof, such as 2-propanol (also referred to as isopropanol, IPA, or isopropyl alcohol), tetrahydrofuran (THF), ethanol, chloroform, acetone, butanol, octanol, pentane, hexane, cyclohexane, and mixtures thereof. In an embodiment where the subphase is a polar liquid (such as water), exemplary liquid carriers that can be utilized include, but are not limited to, 2-propanol, tetrahydrofuan, and ethanol for example. Non-solvent components that can be added to a solvent to form the liquid carrier include, but are not limited to, dispersants, salts, and viscosity modifiers. According to one embodiment, the liquid subphase comprises a material selected from water, heavy water (D₂O), an aqueous salt solution, or combinations thereof.

In some embodiments, the formation of the SERS active layer comprises sputter coating, plasma coating, dip coating, Langmuir-Blodgett deposition, chemical deposition, electrochemical deposition, spin coating, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

Another aspect is to provide methods of detecting spectroscopic signals from analytes in effective contact with embodiments of the substrates. One embodiment is directed to methods of detecting a spectroscopic signal comprising a) bringing at least one analyte into effective contact with a substrate of one embodiment; b) illuminating said analyte with radiation from an excitation source; c) collecting or measuring the Raman scattering from said analyte. In some embodiments, the analyte is chemically bound to the SERS active layer. In some embodiments, the analyte is deposited on the substrate in a gas, liquid, or solid form.

In some embodiments, bringing at least one analyte into effective contact with the substrate comprises having the analyte within sufficient proximity of the SERS active layer to allow for surface enhancement of the spectroscopic signal of the analyte. In some embodiments, effective contact may be obtained through physically, chemically, or mechanically bonding to the analyte to the SERS active layer, physically, chemically, mechanically depositing the analyte, in solid, gas or liquid phase on the SERS active layer, or when may be obtained in gas phase or in solution by passing a gas or liquid across the surface of the SERS active layer.

In some embodiments, illuminating comprises directing electromagnetic radiation at the substrate at a place where at least one analyte is in effective contact with the SERS active layer. In some embodiments, illuminating comprises directing a laser at the substrate. In some embodiments, the laser is pulsed or continuous wave. In some embodiments, the pulse length is on the order of femtoseconds, picoseconds, nanoseconds, or microseconds. In some embodiments, the laser is an gas laser, a chemical laser, a metal vapor laser, a semiconductor laser, or a dye laser. In some embodiments the laser is focused. In some embodiments, the laser is part of an optical system.

Collecting or measuring comprises any practical method for isolating and collecting the Raman signal from the analyte. In some embodiments, collecting or measuring is done with a detector. In some embodiments, the detector is a photomultiplier tube, charge coupled device, photographic film or other chemical detector, photosensor, photodetector, photodiode, photoresistor, optical detector, phototube, phototransistor, cryogenic detector, or LED. In some embodiments, the detector is used in combination with a grating or spectrograph to isolate the Raman signal. In some embodiments, collecting or measuring comprises using a monochrometer, polychrometer, or spectrometer.

Another aspect is to provide a method of increasing Raman signal intensity. One embodiment is directed to a method of increasing a Raman signal intensity during surface-enhanced Raman spectroscopy, comprising providing a substrate of one embodiment; bringing at least one analyte into effective contact with said substrate; and illuminating said analyte with radiation from an excitation source. In some embodiments, the analyte is chemically bound to the SERS active layer. In some embodiments, the analyte is deposited on the substrate in a gas, liquid, or solid form.

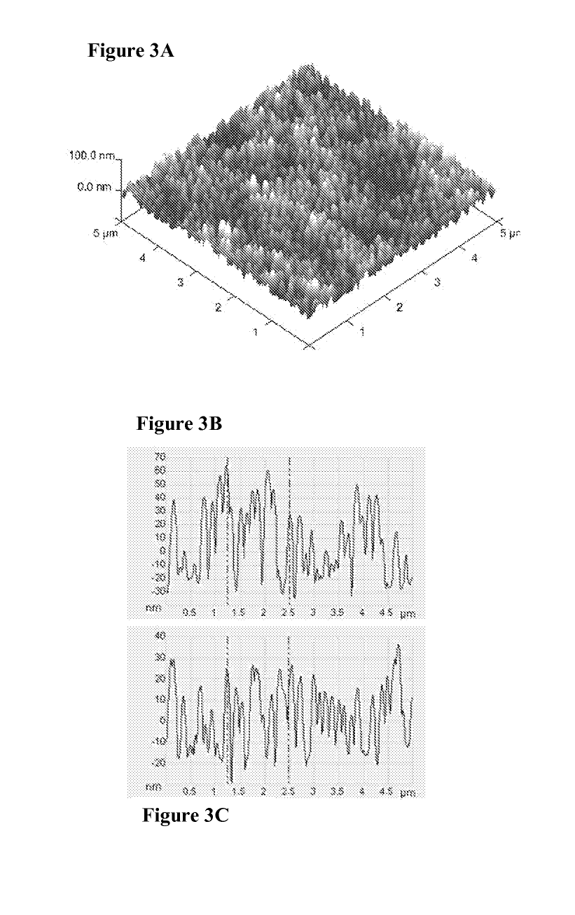

Embodiments are advantageous when compared to the prior art in that they allow for control and optimization of feature size and surface topology, such as roughness and surface height. Embodiments provide for reduced process times and steps. Further, embodiments show high levels of reproducibility and enhancement of Raman signals that are comparable or better than common commercial substrates. In fact, the surface structure is highly homogenous over both the nanometer scale and across the larger substrate. For example, FIG. 5 shows the SERS spectra of methylene blue at five different locations on the same substrate. A comparison of the spectra shows similar peaks and intensities across. Further, FIG. 3 shows the topography of an embodiment across a 5 μm by 5 μm surface area. The variation in surface height is noted in FIGS. 3B and 3C and is approximately 50 nm over the entire 5 mm length.

Embodiments may be constructed entirely of inorganic materials, thus making them useful for SERS at high temperatures, such as in the neighborhood of 300° C. Embodiments may also show long shelf life and have no requirement for protective atmosphere. For example, embodiments that use Au, Pt and other metals have long shelf lives due to low oxidative reactivity of coating compared with other silver coated substrates that are commercially available.

### EXAMPLES

The samples were fabricated using a process comprising dip-coating a near monolayer of silica glass spheres with a diameter of 100 nm followed by heating the substrate in a furnace to attach the particles. For smaller particles, it was found that temperatures well below the softening point of the substrate are sufficient for attaching particles. For the samples described here, 100 nm silica particles from Nissan Chemical (Houston, Tex.) were used. They were dispersed at a concentration of 5% in isopropyl alcohol. The solution was used for dip-coating a soda lime glass substrate with a substrate removal speed of 25 mm/min. The sample was then heated in a furnace to a temperature of 640-650° C. for one hour and then cooled. This temperature is ˜75° C. below the softening point of soda lime glass. The immobilizing layer was a siloxane-based materials in combination with alkali metal silicate materials. Both require a second dip coating for application and low thermal treatment for attachment; typically 300-550° C.

An embodiment of a method was used to produce an active substrate (FIG. 1) that comprises of sintered silica nanospheres and gold film on the top of a support soda lime glass substrate for surface-enhanced Raman spectroscopy. Softened substrate samples first coated with dip-coated 100 nm silica spheres were then coated with gold and tested as surface enhanced Raman scattering substrates using methylene blue dye (C₁₆H₁₈N₃ClS) (“MB”) as the analyte.

FIG. 2 shows the typical SEM images of self-assembled layers of 100 nm SiO₂ sintered on a soda lime glass substrate. It demonstrates the close-packing of those spheres on the substrate from both top view (FIG. 2A) and cross section view (FIG. 2B) and also shows multilayer stacking during the preparation process. On the 2.5″×2.5″ glass substrate, gold films were deposited on 25 different spots by sputter coating for 1 minute, 2 minutes, and 4 minutes, which then yielded gold coatings with estimated thicknesses of 7.5 nm, 15 nm and 30 nm, respectively. The surface topography of sintered glass substrate after gold coating can be observed by AFM (atomic force microscope) in FIG. 3A. Longer gold coating times (4 min) increased Au film thickness, but when compared with 1 min coating clearly decreased the substrate surface roughness (FIG. 3B and FIG. 3C).

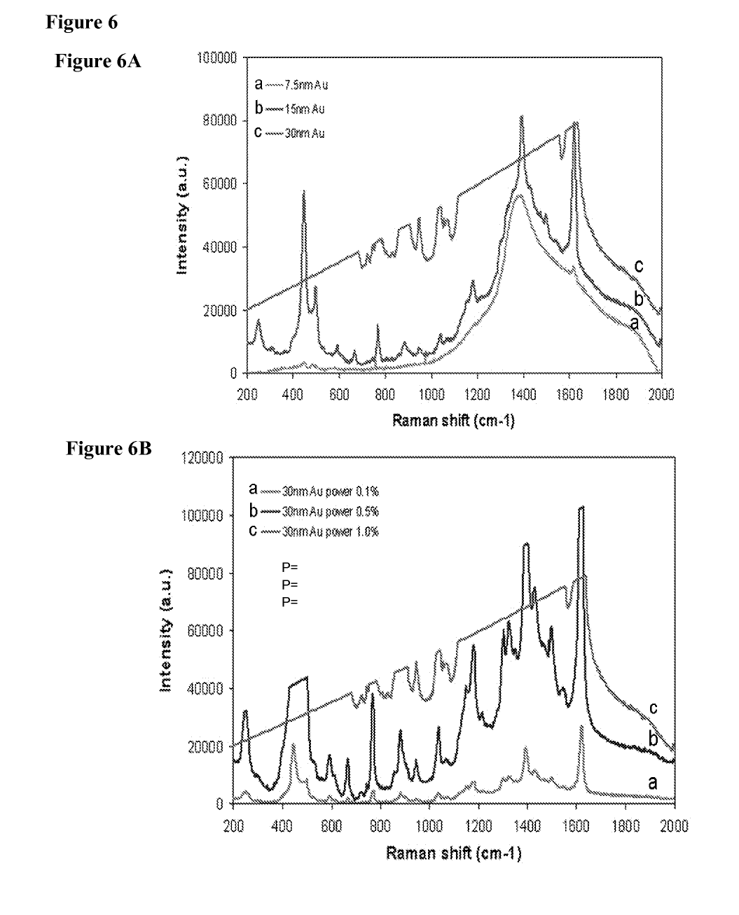

FIG. 3 shows that thicker Au coating reduced the surface roughness, however the decrease in roughness plateaus above 15 nm, as seen in AFM data in the table below. The data was taken from mono and/or double layers of silica nanoparticles on a glass substrate. The notation of “on” or “off” refers to measurement of regions of visible spots and regions in between the spots. Rₐ refers to arithmetic average of absolute values and R_{q} refers to root mean squared. The Rₐ of the 15 nm Au coating is the same as the Rₐ of the 30 nm Au coating. At this point, at the same surface roughness, the thicker Au coating, the higher enhanced Raman intensity will be yielded (See FIG. 6, below). Moreover, as seen from FIG. 6, although with less surface roughness, both 15 nm and 30 nm Au coated substrates have higher Raman enhancement than the 7.5 nm thickness Au coated substrate. For a packing density of 100 nm per 25 μm² area, it was found that metal thicknesses of about 15 nm-45 nm were optimum.

| Sample | R_{q} | | | R_{q} (avg) | Rₐ | | | Rₐ (avg) |
|---|---|---|---|---|---|---|---|---|
| SSL366 off | 24.80 | 23.10 | 27.40 | 25.10 ± 2.17 | 21.00 | 19.50 | 22.30 | 20.93 ± 1.40 |
| SSL366 on | 21.40 | 22.70 | 24.80 | 22.97 ± 1.72 | 18.2 | 18.80 | 21.00 | 19.33 ± 1.47 |
| SSL367 off | 15.00 | 13.80 | 13.70 | 14.17 ± 0.72 | 12.40 | 10.90 | 10.90 | 11.40 ± 0.87 |
| SSL367 on | 13.00 | 16.50 | 13.10 | 14.20 ± 1.99 | 10.90 | 13.90 | 10.90 | 11.90 ± 1.73 |
| SSL394 off | 13.90 | 11.50 | 13.50 | 12.97 ± 1.29 | 11.60 | 9.36 | 11.30 | 10.75 ± 1.22 |
| SSL394 on | 13.90 | 14.70 | 14.40 | 14.33 ± 0.40 | 11.70 | 12.40 | 12.00 | 12.03 ± 0.35 |

Raman spectroscopy, using embodiments, was performed on a high sensitivity laser microscopic Raman spectrometer (Renishaw in Via Raman Microscope, UK). A 785 nm solid state laser was used as excitation source. The excitation beam was focused onto the sample with a 50× objective giving the incident spot size of 2 μm in diameter. The laser power was varied between 0.074˜0.74 mW, and the data acquisition time was 10 s. Spectra were calibrated using the 520 cm⁻¹ band of a silicon wafer. Spectra were collected at room temperature in back-scattering mode. Rayleigh scattering rejection was done with a longpass filter. MB in an ethanol solution was chosen as the test analyte and was diluted to 10⁻² M. We applied 2 μL, of this solution over approximately <1 cm² of substrate area and allowed to dry.

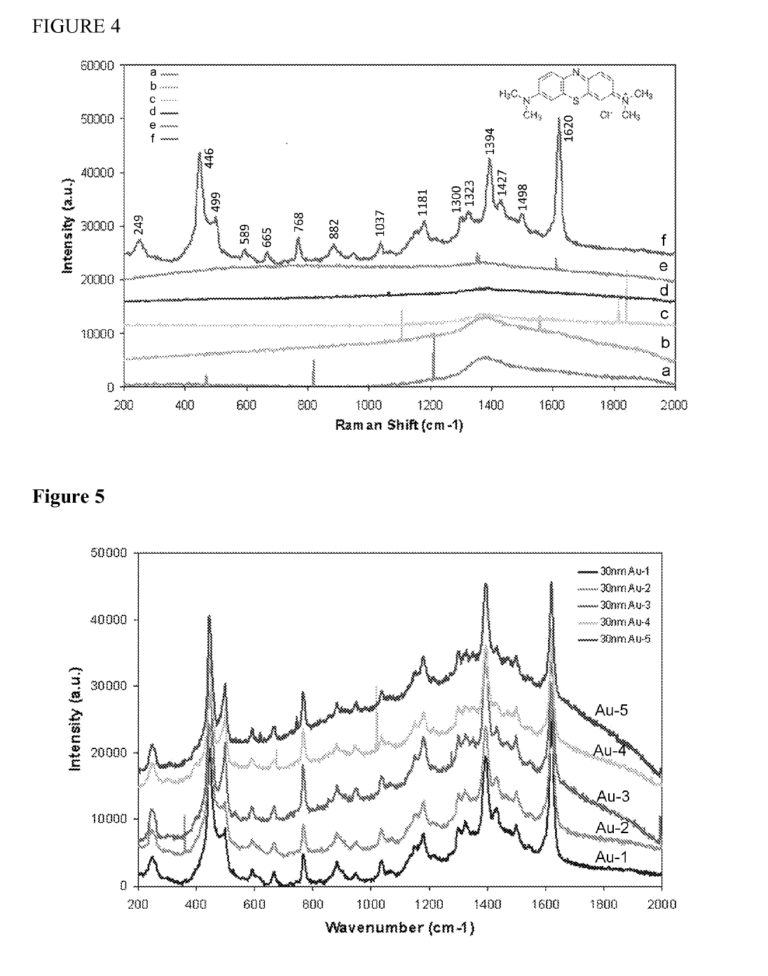

FIG. 4 compares the Raman spectra of a glass substrate, MB on a glass substrate, a gold-coated substrate, and an embodiment as disclosed herein. Among all the controls, the normal Raman spectra show only a broad peak around 1375 cm⁻¹ from the MB. The corresponding SERS spectrum (FIG. 4, f) shows significant details not available in the normal Raman spectra. The characteristic peaks of MB around 1620 cm⁻¹ and 446 cm⁻¹ which have been assigned to the ring stretch mode and C—N—C skeletal bending in the SERS spectra respectively, indicating that the molecules were adsorbed on the substrates well. The strong asymmetric stretching vibration of C—N appeared at 1394 cm⁻¹ while symmetric C—N stretching is observed at 1181 cm⁻¹. The band of 1394 cm⁻¹ may involve C—H in-plane ring deformation. The band at 768 cm⁻¹ can be assigned to C—H out-of-plane bending and skeletal deformation of C—N—C can be seen at 499 cm⁻¹. The power of SERS is evident in this spectral example. Not only is more information obtained by the use of SERS to probe this molecule but as the surface concentration of the molecule changes the spectra may change to indicate either monolayer or multilayer coverage.

To assess uniformity of the substrate across the surface of the glass substrate, a single concentration of MB was analyzed across multiple locations (5 spots) along the diagonal direction on the 30 nm Au coated surface. As demonstrated in FIG. 5, almost identical band locations and peaks were obtained, showing the uniformity of the SERS active substrate.

FIG. 6 demonstrate the effects of gold coating thickness and laser power for SERS signals. The SERS spectra of MB adsorbed on top of 100 nm SiO₂ spheres with different thickness of gold coating (7.5 nm, 15 nm and 30 nm) were measured under same detection condition (10 s, 1% laser power). As shown in FIG. 6a, the thicker the gold coating, the stronger the Raman signal observed. It was also found that 1% laser power is too strong for 30 nm Au coated glass substrate that only saturated bands were observed. Therefore, various laser powers were used (1%, 0.5% and 0.1%), as seen in FIG. 6b it is evident that a good SERS signal of 30 nm Au coated substrate can be obtained at only 0.1% power (0.07 mW), which is 100× lower that the power used for previous nanostructured phase-separated glass substrates.

The Raman enhancement factor is defined as:

$$G = \frac{{I}_{enh} / {N}_{ads}}{{I}_{ref} / {N}_{ref}} ,$$

where Iₑₙₕ and I_{ref} are the integrated intensities of the same band for the adsorbed MB in the SERS spectra and the MB molecules in the Raman spectra of solid MB powders respectively.

N_{ads} is the number of molecules covering the SERS active substrate within the laser spot area, and N_{ref} is the number of molecules contributing to the normal Raman spectra of solid MB powder under the laser spot.

If we assume a monolayer of MB molecules adsorbed on substrate as reported previously, under the area of laser spot 4 um², N_{ads}≈5×10⁶ (MB molecule diameter˜0.9 nm). For a scattering volume of 440 um³, N_{ref} is approximately

1.5×10¹²(N_{ref}=6.022×10²³/mol*40 μm³*1.759 g/cm³/319.86 g/mol*1 cm³/10¹² μm³).

The enhancement per molecule can be estimated according to the following equation:

G=3.0×10⁵*Iₑₙₕ/I_{ref}

The SERS enhancement factor for peak 1620 cm⁻¹ of MB adsorbed on 30 nm Au coated silica sintered glass substrate is estimated to be

Iₑₙₕ(1620 cm¹)2.26×10⁴*20/10=5.52×10⁴ cm⁻¹cps

N_{ref}(1620 cm⁻¹)5460*10/100=546 cm⁻¹cps

Then G(1620 cm⁻¹)≈3.0×10⁷

The above calculated enhancement factor was obtained assuming that only monolayer MB was adsorbed on the substrate. As an comparative estimate, if we consider the MB concentration 0.01M and 2 μl, we will have total 2×10⁻⁸ mol MB molecules adsorbed on an approximately 1 cm² area, then for the laser spot area 4 μm², N_{ads}=2×10⁻⁸*6.022×10²³*4 um²/1 cm²≈5*10⁸, which is actually corresponding up to 100 monolayers of MB, and then G=3.0*10⁵. Therefore, based on calculations, embodiments are able to provide signal enhancement on the order of at least about 10⁵ to about 10⁷.

We claim:

1. A substrate comprising:
a) a support element;
b) a nanoparticulate layer;
c) a surface enhanced Raman spectroscopy active layer in contact with said nanoparticulate layer; and
d) optionally, an immobilizing layer disposed between said nanoparticulate layer and said support element;
wherein:
e) when said optional immobilizing layer is not present, said nanoparticulate layer is thermally bonded to said support element; and
f) when said optional immobilizing layer is present, said nanoparticulate layer is thermally bonded to said immobilizing layer, and optionally, further thermally bonded to said support element.

2. The substrate of claim 1, wherein:
when said optional immobilizing layer is not present, said thermal bonding of the nanoparticulate layer to the support element comprises embedding of said nanoparticulate layer into said support element; and
when said optional immobilizing layer is present, said thermal bonding of the nanoparticulate layer to the support element comprises embedding of said nanoparticulate layer into said immobilizing layer, and optionally, embedding into said support element.

3. The substrate of claim 1, wherein the nanoparticulate layer comprises nanoparticles having an average radius of from about 5 nm to about 5,000 nm.

4. The substrate of claim 3, wherein the average peak-to-peak distance of the nanoparticles comprises from about 2 radii to about 100 radii of the average radius of the nanoparticles along the shortest dimension.

5. The substrate of claim 4, wherein the nanoparticulate layer comprises nanoparticles comprising at least one of glass, ceramic, metal, polymer, metal oxide, metal salt, or fullerenes.

6. The substrate of claim 1, wherein the nanoparticulate layer comprises nanoparticles having a softening point higher than the softening point of said support element or said optional immobilizing layer.

7. The substrate of claim 1, wherein said surface enhanced Raman spectroscopy active layer comprises at least one of a transition metal.

8. The substrate of claim 1, wherein the total thickness of the surface enhanced Raman spectroscopy active layer is about 5 nm to about 1000 nm.

9. The substrate of claim 1, wherein the support element comprises glass, quartz, ceramic, metal, inorganic elements or compounds, wood, paper, or polymer.

10. The substrate of claim 1, wherein the support element comprises glass, the nanoparticulate layer comprises nanoparticles, and the metal layer comprises at least one of Ag, Al, Au, Pt, Cu, Fe, Ru, Rh, Pd, Os, Ir, Ni, Zn, Mn, or Co, wherein the average peak-to-peak distance of the nanoparticles comprises from about 2 radii to about 100 radii of the average radius of the nanoparticles along the shortest dimension.

11. A method of forming the substrate claim 1, comprising:
a) providing a support element;
b) forming a nanoparticulate layer on said support to form a coated support element;
c) optionally forming an immobilizing layer on said support element or said coated support element;
d) heating said coated support element to a temperature that allows said nanoparticulate layer to bond to said support element, to said optional immobilizing layer, or to both said support element and said optional immobilizing layer to form a thermally treated support element; and
e) forming a surface enhanced Raman spectroscopy active layer on said thermally treated support element.

12. The method of claim 11, wherein:
when said optional immobilizing layer is not present, said bonding of the nanoparticulate layer to the support element comprises embedding of said nanoparticulate layer into said support element; and
when said optional immobilizing layer is present, said bonding of the nanoparticulate layer to the support element comprises embedding of said nanoparticulate layer into said immobilizing layer, and optionally, embedding into said support element.

13. The method of claim 11, wherein the nanoparticulate layer comprises nanoparticles having an average radius of from about 5 nm to about 5,000 nm.

14. The method of claim 13, wherein the average peak-to-peak distance of the nanoparticles comprises from about 2 radii to about 100 radii of the average radius of the nanoparticles along the shortest dimension.

15. The method of claim 11, wherein the nanoparticulate layer comprises nanoparticles having a softening point higher than the softening point of said support element or said optional immobilizing layer.

16. The method of claim 11, wherein the optional immobilizing layer is not present and said heating is above the softening point of said support element, but below the softening point of said nanoparticulate layer.

17. The method of claim 11, wherein the optional immobilizing layer is present and said heating is below the softening point of said optional immobilizing layer, and below the softening point of said nanoparticulate layer.

18. The method of claim 11, wherein said forming a nanoparticulate layer comprises dip coating, spin coating, Langmuir-Blodgett deposition, electrospray ionization, direct nanoparticle deposition, vapor deposition, chemical deposition, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

19. The method of claim 11, wherein said forming a metal layer comprises sputter coating, plasma coating, dip coating, Langmuir-Blodgett deposition, chemical deposition, electrochemical deposition, spin coating, vacuum filtration, flame spray, electrospray, spray deposition, electrodeposition, screen printing, close space sublimation, nano-imprint lithography, in situ growth, microwave assisted chemical vapor deposition, laser ablation, arc discharge or chemical etching.

20. A method of detecting a spectroscopic signal comprising:
a) bringing at least one analyte into effective contact with the substrate of claim 1;
b) illuminating said analyte with radiation from an excitation source;
c) collecting or measuring the Raman scattering from said analyte.

21. A method of increasing a Raman signal intensity during surface-enhanced Raman spectroscopy, comprising:
a) providing the substrate of claim 1;
b) bringing at least one analyte into effective contact with said substrate; and
c) illuminating said analyte with radiation from an excitation source.
